(19) United States
(12) Patent Application Publication
(10) Pub. No.: US 2012/0113175 A1
(43) Pub. Date: May 10, 2012

(54) Driving apparatus of inkjet printer head and driving method thereof

(75) Inventors: Hyun Seok Lee, Seoul (KR); Na Rae Park, Gyeonggi-do (KR); Chang Soo Kang, Gyeonggi-do (KR)

(73) Assignee: Samsung Electro-Mechanics Co., Ltd., Suwon (KR)

(21) Appl. No.: 12/929,478

(22) Filed: Jan. 27, 2011

(30) Foreign Application Priority Data
Nov. 8, 2010 (KR) 10-2010-0110370

(51) Int. Cl. B41J 29/38

(52) U.S. Cl. 347/10

(57) ABSTRACT

Disclosed herein is a driving apparatus for an inkjet printer head including: a controller generating and outputting pulse control signals for driving an inkjet printer head; a level switching unit operated to be switched according to the pulse control signals to output a predetermined level of switching signals; a driver selectively controlling a plurality of nozzles by using the driving waveforms generated by combining the switching signals, whereby the inkjet printer head can be implemented simpler at low cost.

### CROSS REFERENCE(S) TO RELATED APPLICATIONS

This application claims the benefit under 35 U.S.C. Section [120, 119, 119(e)] of Korean Patent Application Serial No. 10-2010-0110370, entitled “Driving Apparatus of Inkjet Printer Head and Driving Method Thereof” filed on Nov. 8, 2010, which is hereby incorporated by reference in its entirety into this application.

### BACKGROUND OF THE INVENTION

1. Technical Field

The present invention relates to a driving apparatus of an inkjet printer head and a driving method thereof, and more particularly, to a driving apparatus of an inkjet printer head capable of being implemented simply and at low cost by using a high-speed level switching unit receiving pulse control signals and outputting high-voltage switching signals, and a driving method thereof.

2. Description of the Related Art

An inkjet printer is a scheme that sprays small ink drops through a plurality of nozzles formed on an inkjet printer head and prints the paper. The inkjet printer is configured to accurately spray ink at desired positions through the plurality of nozzles.

An example of a scheme of spraying ink may include a scheme of using pressure and a scheme of using heat. Among others, the scheme of using pressure applies a predetermined voltage to an upper electrode and a lower electrode of a piezo electric element to generate a potential difference therebetween and sprays ink by using a pressure difference generated due to the potential difference.

To this end, a driving apparatus of an inkjet printer head includes a digital to analog converter (DAC) and a multi-stage amplifier (AMP) to convert digital signals into analog signals according to signals applied from the outside and to amplify the converted analog signals to high-voltage analog signal, thereby generating driving signals for driving the inkjet printer head.

However, the above-mentioned driving apparatus according to the related art uses the multi-stage amplifier, such that a system for implementing the driving apparatus is complicated when implementing a multi-head.

As a result, there is a problem in increasing manufacturing costs.

### SUMMARY OF THE INVENTION

An object of the present invention is to provide a driving apparatus of an inkjet printer head capable of being implemented simply and at low cost by using a high-speed level switching unit receiving pulse control signals and outputting high-voltage switching signals, and a driving method thereof.

According to an exemplary embodiment of the present invention, there is provided a driving apparatus of an inkjet printer head, including: a controller generating and outputting pulse control signals for driving an inkjet printer head; a level switching unit operated to be switched according to the pulse control signals to output a predetermined level of switching signals; and a driver selectively controlling a plurality of nozzles by using the driving waveforms generated by combining the switching signals.

The pulse control signal may be a pulse width modulation (PWM) signal.

The controller may control the duty ratio of the pulse width modulation signal to control the width and level of the switching signal.

The controller may control the duty ratio of the pulse width modulation signal to control the rising time and the falling time of the driving waveform.

The driving apparatus of an inkjet printer head may further include a selection switching unit operated to be switched in order to selectively apply the predetermined level of switching signal to the plurality of nozzles.

The selection switching unit may be configured in plural, corresponding to a plurality of nozzles.

The selection switching unit may be a demultiplexer.

The controller may output a selection control signal controlling the switching operation of the selections switching unit to the selection switching unit in order to selectively discharge ink from the plurality of nozzles.

The predetermined level of switching signal may have a voltage level that is a reference level or more.

According to an exemplary embodiment of the present invention, there is provided a driving method of an inkjet printer head, including: generating and outputting pulse control signals for driving the inkjet printer head; outputting a predetermined level of switching signals by performing a switching operation according to the pulse control signals; selectively outputting the predetermined level of switching signals by performing the switching operation in order to selectively apply the predetermined level of switching signals to a plurality of nozzles; and selectively controlling the plurality of nozzles by using driving waveforms generated by combining the output switching signals.

The pulse control signal may be a pulse width modulation (PWM) signal.

The driving method of an inkjet printer head may further include controlling the width and level of the switching signals by controlling the duty ratio of pulse width modulation signal prior to generating and outputting the pulse control signals for driving the inkjet printer head.

The driving method of an inkjet printer head may further include controlling the rising time and the falling time of the driving waveform by controlling the duty ratio of the pulse width modulation signal prior to generating and outputting the pulse control signals for driving the inkjet printer head.

### BRIEF DESCRIPTION OF THE DRAWINGS

FIG. 1 is a block configuration diagram of a driving apparatus of an inkjet printer head according to an exemplary embodiment of the present invention;

FIG. 2 is a graph showing pulse controls signals output from a controller shown in FIG. 1;

FIG. 3 is a graph showing switching signals output from a level switching unit shown in FIG. 1;

FIG. 4A is a graph showing a plurality of switching signals according to a charging and discharging state;

FIG. 4B is a graph showing driving waveforms generated by combining a plurality of switching signals shown in FIG. 4A;

FIG. 5 is a graph showing results measured for each level for the driving waveforms applied to nozzles of the inkjet printer head according to an exemplary embodiment of the present invention; and

FIG. 6 is an operational flow chart showing a driving method of an inkjet printer head according to an exemplary embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings.

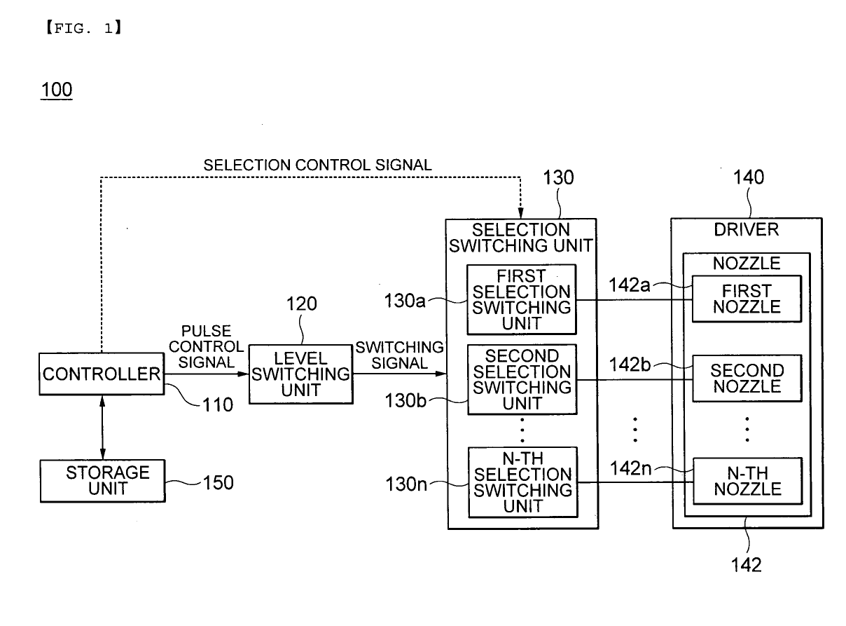

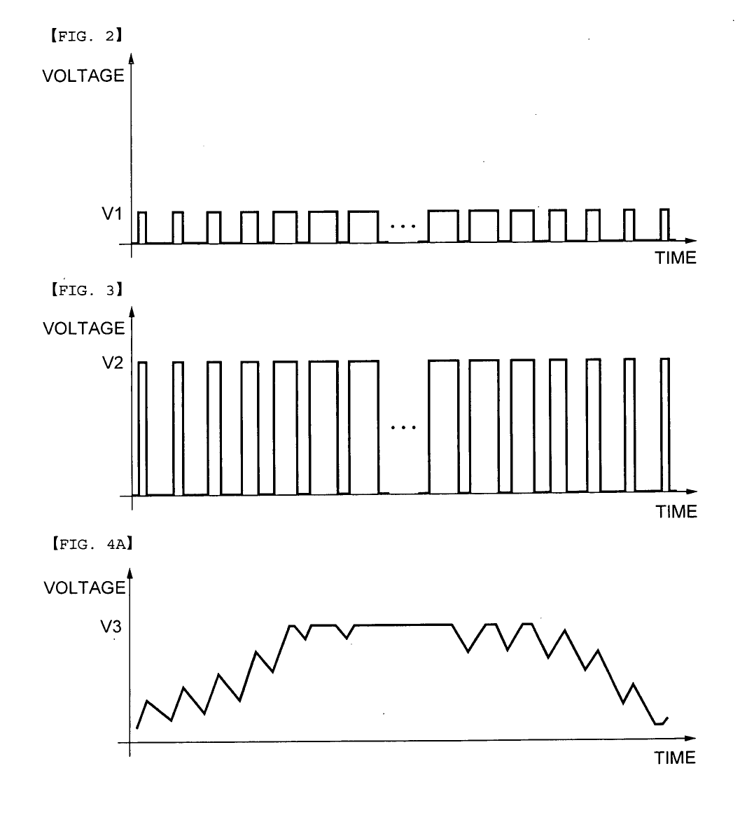

FIG. 1 is a block configuration diagram of a driving apparatus of an inkjet printer head according to an exemplary embodiment of the present invention and FIG. 2 is a graph showing pulse controls signals output from a controller shown in FIG. 1.

As shown in FIG. 1, a driving apparatus 100 of an inkjet printer head is configured to include a controller 110, a level switching unit 120, a selection switching unit 130, a driver 140, and a storage unit 150.

First, prior to describing the driving apparatus 100 of an inkjet printer head, the inkjet printer head will be briefly described. The inkjet printer head is configured to include a piezo electric element (not shown) and a first electrode and a second electrode (not shown) each provided on the upper portion and the lower portion of the piezo electric element.

The piezo electric element is a vibrator produced by sintering a piezo electric material, which is referred to as a piezo electric element generating electricity when a mechanical force is applied to thereto or generating a mechanical force when electricity is applied to thereto. An example of the piezo electric material may include crystal, tourmaline, Rochelle salts, or the like. An artificial crystal such as barium titanate, monoammonium phosphate, tartaric acid ethylenediamine, or the like, is also used as a piezo electric material having excellent piezo electric property.

The piezo electric element is subjected to a deformable motion such as extension, flexibility, etc., when a driving waveform Vo is applied thereto through the first and second electrodes (i.e., if there is the potential difference between both electrodes), such that it is operated as a kind of pump pressing ink sprayed through nozzles.

Hereinafter, components of the driving apparatus 100 of an inkjet printer head will be described.

First, the controller 110 is a micom generally controlling the driving apparatus 100 of an inkjet printer head and generates and outputs a pulse control signal PC when the external signal (for example, a trigger signal) for driving the inkjet printer head from the outside.

In this case, as shown in FIG. 2, the pulse control signal PC is a pulse width modulation (PWM) signal capable of controlling a duty ratio and is configured as a digital signal of a low voltage V1 in which a voltage level is below a reference level.

Further, the controller 110 outputs a selection control signal SC controlling a selection switching unit 130 in order to selectively discharge ink from the inkjet printer head, i.e., a plurality of nozzles 142 and 142a to 142n. This will be described in more detail below when the selection switching unit 130 is described.

The level switching unit 120 is a unit of outputting a predetermined level of switching signal HS by performing a switching operation according to the pulse control signal PC output from the controller 110 and may be configured as a switching device such as a metal-oxide-semiconductor field effect transistor (MOSFET).

Described in more detail, the level switching unit 120 is operated to be turned-on when the pulse control signal PC output from the controller 110 is in a high state to output the high-voltage switching signal HS and is operated to be turned-off when the pulse control signal PC output from the controller 110 is in a low state not to discharge ink from the nozzle 142.

In this case, since the level switching unit 120 is configured as the switching device such as a MOSFET, it may serve to increase low voltage to high voltage, together with the switching operation in the switching device.

FIG. 3 is a graph showing a switching signal output from a level switching unit shown in FIG. 1. As shown in FIG. 3A, a predetermined level of switching signal HS is configured as the switching signal HS of high voltage V2 in which the voltage level is a reference level or more and has the same duty ratio as the pulse control signal PC of FIG. 2, such that the duty ratio of the pulse control signal PC output from the controller 110 is controlled, thereby making it possible to control the width and level of the switching signal HS.

In addition, the level switching unit 120 is operated at high speed, such that it outputs the switching signal HS at higher speed as compared to the scheme according to the related art.

The selection switching unit 130 (130a to 130n) is operated to be turned-on or turned-off according to the selection control signal SC output from the controller 110 to selectively apply the switching signal HS output from the level switching unit 120 to the driver 140.

The selection switching units 130a to 130n are configured in plural, corresponding to a plurality of nozzles 142 (142a to 142n).

Described in more detail, when the selection control signal SC for controlling the nozzle 142 in the controller 110 is applied to the selection switching units 130a to 130n in order to selectively discharge ink, some of the plurality of selection switching units 130a to 130n are operated to be turned-on and the remaining thereof are operated to be turned-off to selectively apply the switching signals applied from the level switching unit 120 to the plurality of nozzles 142 (142a to 142n) formed in the inkjet printer head through the driver 140.

The selection switching units 130a to 130n is configured of a demultiplexer having a single input and a plurality of outputs. The plurality of selection switching units 130a to 130n are operated to be selectively switched according to the selection control signals output from the controller 110 to provide a control to discharge ink from the corresponding nozzles.

The driver 140 selectively controls the plurality of nozzles 142 (142a to 142n) by using the driving waveforms generated by combining the output switching signals.

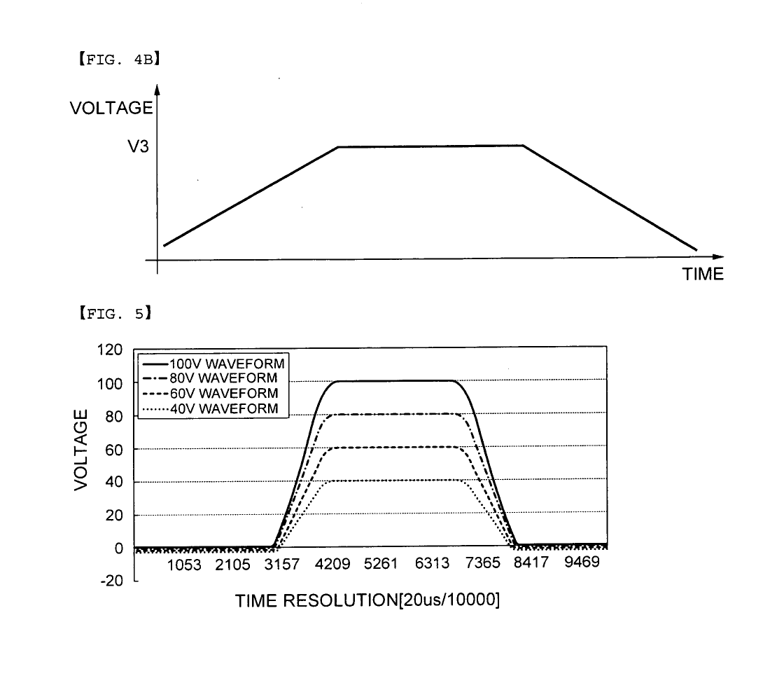

FIG. 4A is a graph showing a plurality of switching signals according to a charging and discharging state and FIG. 4B is a graph showing driving waveforms generated by combining a plurality of switching signals shown in FIG. 4A.

Described in more detail with reference to FIGS. 4A and 4B, the driver 140 driving each nozzle 142 (142a to 142n) of the inkjet printer head, i.e., an actuator of the inkjet printer head has equivalently a capacitance value, such that the applied switching signals repeats the charging and discharging state.

If the case in which the pulse control signal is high is a turned-on state and the case in which the pulse control signal is low is a turned-off state, the waveforms shown in FIG. 4A are generated.

As shown in FIG. 4A, since the driver 140 driving each nozzle 142 (142a to 142n) of the inkjet head, that is, the actuator of the inkjet printer head has the capacitance value, when the switching signal HS is applied, the actuator is charged during the turn-on state and is then discharged at the instant when it is in a turned-off state. Therefore, the charged and discharged signal has a shape in which the level of the signal is increased and then decreased in a step shape, at both ends.

Therefore, since the charging and discharging time is varied according to the duty ratio of the switching signal HS, the shape of the driving waveform V3 may be varied by controlling the duty ratio of the pulse control signal PC in the controller 110.

The overall shape of the driving waveform shown in FIG. 4A has a shape of a kind of square wave having a rising time and a falling time as shown in FIG. 4B.

The rising time and the falling time of the square wave can be controlled by controlling the duty ratio in the controller 110 as described above.

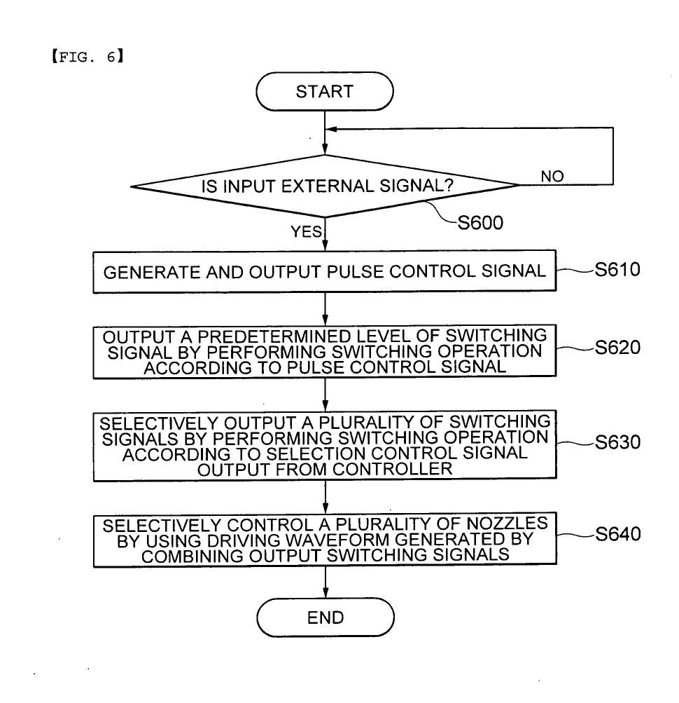

FIG. 5 is a graph showing results measured for each level for the driving waveforms applied to nozzles of the inkjet printer head according to an exemplary embodiment of the present invention. As shown in FIG. 5, the driving waveforms applied to the nozzle of the inkjet printer head according to the voltage levels of 40v, 60v, 80v, and 100v are shown.

Consequently, when the plurality of switching signals HS are combined, since the driving waveforms having the square shape as shown in FIG. 5 is generated, they have a shape approximately similar to the waveforms of the signals generated by using the DAC and the amplifier according to the related art but the system may be implemented simpler and at low cost.

The storage unit 150 is a storage unit including a read only memory (ROM) storing a series of processing programs and a random access memory (RAM) temporarily storing calculation results and stores a control program, etc., for controlling the driving apparatus 100 of an inkjet printer head.

The driving method of an inkjet printer head according to an exemplary embodiment of the present invention will be described below.

FIG. 6 is an operational flow chart showing a driving method of an inkjet printer head according to an exemplary embodiment of the present invention.

Referring to FIG. 6, the controller 110 confirms whether a signal (that is, a trigger signal) is input from the outside (S600) and then, when the external signals are input (‘Yes’ at S600), it generates and outputs the pulse control signal PC (S610).

In this case, the controller 110 periodically outputs the pulse control signal PC according to the driving frequency of the inkjet printer head to periodically and consecutively output the pulse control signal PC and the pulse control signal PC is configured as the pulse width modulation (PWM) signal whose duty ratio can be controlled.

The level switching unit 120 is operated to be switched according to the pulse control signal PC to output a predetermined level of switching signal HS (S620).

In this case, the predetermined level of switching signal HS is configured as the high-voltage switching signal in which the voltage level is a reference level or more and the controller 110 can control the duty ratio of the pulse width modulation (PWM) signal in the controller 110 in order to control the width and level of the switching signal HS.

Next, the plurality of switching signals HS are selectively output by the switching operation according to the selection control signal SC output from the controller 110 (S630).

Thereafter, the driver 140 selectively controls the plurality of nozzles 142 (142a to 142n) of the inkjet printer head by using the driving waveforms generated by combining the switching signals HS (S640).

In this case, the duty ratio of the pulse width modulation signal can be controlled by controlling the rising time and the falling time of the driving waveform.

As set forth above, the driving apparatus of an inkjet printer head and the driving method thereof according to an exemplary embodiment of the present invention can be implemented simpler than the scheme of using the digital to analog converter and the plurality of amplifiers of the related art, thereby making it possible to more easily manufacture the system even in the case of using the multi-head.

As a result, the present invention can save the manufacturing costs.

In addition, the present invention can miniaturize the driving apparatus to less have space constraints.

In addition, the present invention controls the duty ratio to control the width and level of the high-voltage switching signal, thereby making it possible to easily control the driving waveform for driving the inkjet printer head.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

What is claimed is:

1. A driving apparatus of an inkjet printer head, comprising:
a controller generating and outputting pulse control signals for driving an inkjet printer head;
a level switching unit operated to be switched according to the pulse control signals to output a predetermined level of switching signals; and
a driver selectively controlling a plurality of nozzles by using the driving waveforms generated by combining the switching signals.

2. The driving apparatus of an inkjet printer head according to claim 1, wherein the pulse control signal is a pulse width modulation (PWM) signal.

3. The driving apparatus of an inkjet printer head according to claim 2, wherein the controller controls the duty ratio of the pulse width modulation signal to control the width and level of the switching signal.

4. The driving apparatus of an inkjet printer head according to claim 2, wherein the controller controls the duty ratio of the pulse width modulation signal to control the rising time and the falling time of the driving waveform.

5. The driving apparatus of an inkjet printer head according to claim 1, further comprising a selection switching unit operated to be switched in order to selectively apply the predetermined level of switching signal to the plurality of nozzles.

6. The driving apparatus of an inkjet printer head according to claim 5, wherein the selection switching unit is configured in plural, corresponding to a plurality of nozzles.

7. The driving apparatus of an inkjet printer head according to claim 5, wherein the selection switching unit is a demultiplexer.

8. The driving apparatus of an inkjet printer head according to claim 5, wherein the controller outputs a selection control signal controlling the switching operation of the selections switching unit to the selection switching unit in order to selectively discharge ink from the plurality of nozzles.

9. The driving apparatus of an inkjet printer head according to claim 1, wherein the predetermined level of switching signal has a voltage level that is a reference level or more.

10. A driving method of an inkjet printer head, comprising:
generating and outputting pulse control signals for driving the inkjet printer head;
outputting a predetermined level of switching signals by performing a switching operation according to the pulse control signals;
selectively outputting the predetermined level of switching signals by performing the switching operation in order to selectively apply the predetermined level of switching signals to a plurality of nozzles; and
selectively controlling the plurality of nozzles by using driving waveforms generated by combining the output switching signals.

11. The driving method of an inkjet printer head according to claim 10, wherein the pulse control signal is a pulse width modulation (PWM) signal.

12. The driving method of an inkjet printer head according to claim 10, further comprising controlling the width and level of the switching signals by controlling the duty ratio of pulse width modulation signal prior to generating and outputting the pulse control signals for driving the inkjet printer head.

13. The driving method of an inkjet printer head according to claim 10, further comprising controlling the rising time and the falling time of the driving waveform by controlling the duty ratio of the pulse width modulation signal prior to generating and outputting the pulse control signals for driving the inkjet printer head.
